(19) United States
(12) Patent Application Publication
(10) Pub. No.: US 2024/0086302 A1
(43) Pub. Date: Mar. 14, 2024

(54) CONNECTIVITY MANAGEMENT DEVICE, SYSTEM, METHOD

(71) Applicant: Hitachi, Ltd., Tokyo (JP)

(72) Inventor: Daisuke ISHII, Santa Clara, CA (US)

(21) Appl. No.: 17/939,740

(22) Filed: Sep. 7, 2022

(51) Int. Cl. G06F 11/36

(52) U.S. Cl. CPC G06F 11/3608

(57) ABSTRACT

Systems and methods described herein can involve, for an occurrence of a connection error between a first software and a second software, obtaining information comprising a plurality of context categories, each of the plurality of context categories associated with an operating environment of the first software and the second software; searching an error history database based on the information and weight values associated with each of the plurality of context categories; and providing an estimated cause of the connection error based on the searching.

### BACKGROUND

### Field

The present disclosure is generally related to software connectivity management systems, and more specifically, towards searching for causes of the connection error.

### Related Art

To expand the business potential of an Internet of Things (IoT) software such as a data collection platform, the data collection platform may be required to install in various environments and to connect to various other data collection platforms. Different errors can occur in each environment, which introduces bottlenecks. The store and utilization of know-how can also be challenging.

In related art implementations, there can be a management suite error log analysis system that enables users, including engineers and technical support personnel, to quickly and effectively determine a root cause of an error and to suggest possible solutions to the error. However, such related art implementations do not address the differences that can occur regarding installation environments and worker skills.

### SUMMARY

Example implementations described herein store the history of connection errors and their solutions as knowledge, and provides error cause candidates while taking software installation environments and worker skills into consideration. The example implementations search the candidates of connection error causes precisely in consideration of software installation environments and work skills.

In example implementations, there can be systems and methods system communicating data between at least two software, which can involve having a context table managing a plurality of context categories (e.g., data format, network environment, computing environment, and so on categorized based on the scope each of context could influence) with associated weight value, and when the error is recognized as a result of implementation work, example implementations search an error history database considering context information and associated weight value, and output the estimated cause of the error.

Aspects of the present disclosure can include a method, which can include, for an occurrence of a connection error between a first software and a second software, obtaining information comprising a plurality of context categories, each of the plurality of context categories associated with an operating environment of the first software and the second software; searching an error history database based on the information and weight values associated with each of the plurality of context categories; and providing an estimated cause of the connection error based on the searching.

Aspects of the present disclosure can include a computer program, which can include instructions involving, for an occurrence of a connection error between a first software and a second software, obtaining information comprising a plurality of context categories, each of the plurality of context categories associated with an operating environment of the first software and the second software; searching an error history database based on the information and weight values associated with each of the plurality of context categories; and providing an estimated cause of the connection error based on the searching. The computer program and the instructions can be stored on a non-transitory computer readable medium and executed by one or more processors.

Aspects of the present disclosure can involve an apparatus, which can involve a processor, configured to, for an occurrence of a connection error between a first software and a second software, obtain information comprising a plurality of context categories, each of the plurality of context categories associated with an operating environment of the first software and the second software; search an error history database based on the information and weight values associated with each of the plurality of context categories; and provide an estimated cause of the connection error based on the searching.

Aspects of the present disclosure can include a system, which can include, for an occurrence of a connection error between a first software and a second software, means for obtaining information comprising a plurality of context categories, each of the plurality of context categories associated with an operating environment of the first software and the second software; means for searching an error history database based on the information and weight values associated with each of the plurality of context categories; and means for providing an estimated cause of the connection error based on the searching.

### BRIEF DESCRIPTION OF DRAWINGS

FIG. 1 illustrates an example of a connectivity management system that can be used to implement the device, the system, and the method of the example implementations described herein.

FIG. 2 illustrates an example of a category definition, in accordance with an example implementation.

FIG. 3 illustrates an example of Category DB, in accordance with an example implementation.

FIGS. 4(a) and 4(b) illustrate an example of Weight DB, in accordance with an example implementation.

FIG. 5 illustrates a flow chart of the operations of the error cause search, in accordance with an example implementation.

FIG. 6 illustrates an example of Knowledge DB, in accordance with an example implementation.

FIG. 7 illustrates a flow chart of the score calculation method which corresponds to 706 in FIG. 5, in accordance with an example implementation.

FIGS. 8(a) and 8(b) illustrate an example of the score calculation, in accordance with an example implementation.

FIG. 9 illustrates an example of Category Spec Input GUI, in accordance with an example implementation.

FIG. 10 illustrates an example of a User Skill Input GUI, in accordance with an example implementation.

FIGS. 11(a) and 11(b) illustrate examples of Error Input GUI, which are two methods to input the information, in accordance with an example implementation.

FIG. 12 illustrates an example of Error Cause Suggestion Output GUI, in accordance with an example implementation.

FIG. 13 illustrates an example of the Re-configuration Rule, in accordance with an example implementation.

FIG. 14 illustrates an example of Category Definition GUI, in accordance with an example implementation.

FIG. 15 illustrates an example of Weight Definition GUI, in accordance with an example implementation.

FIG. 16 illustrates an example of Re-configuration Rule Definition GUI to register a program to fix an error, in accordance with an example implementation.

FIG. 17 illustrates an example of Knowledge DB Update GUI to register connection error history information, in accordance with an example implementation.

FIG. 18 illustrates a flow chart of the re-configuration process, in accordance with an example implementation.

FIG. 19 shows an example of the script file script02.sh for the re-configuration, in accordance with an example implementation.

FIG. 20 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

In this following description, as one of implementation examples, the combination of data collection platform software is explained as follows.

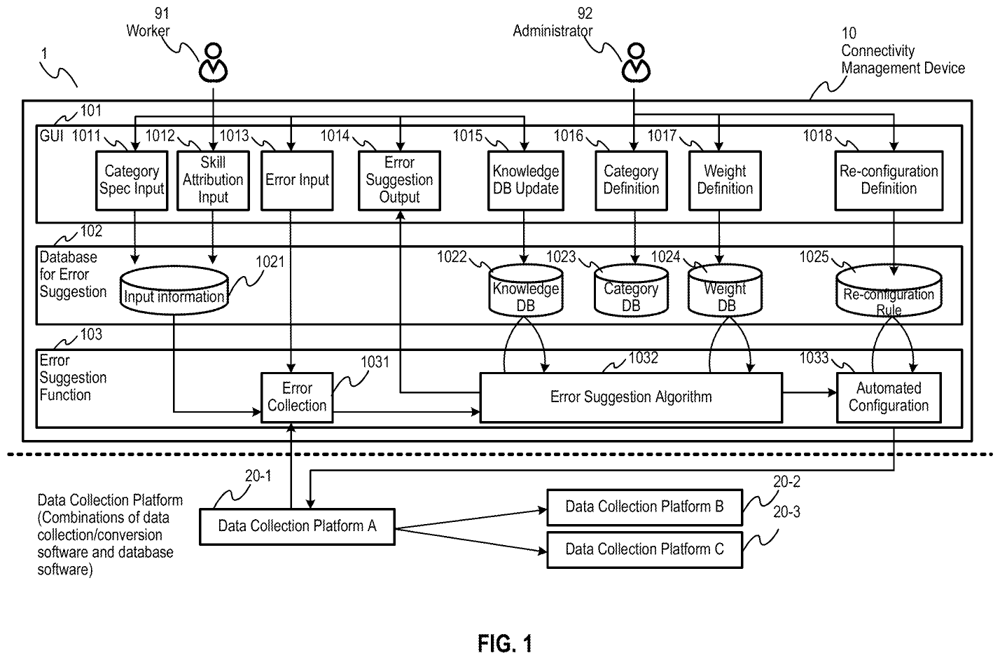

FIG. 1 illustrates an example of a connectivity management system 1 that can be used to implement the device, the system, and the method of the example implementations described herein. The connectivity management system can involve a connectivity management device, and several data collection platform software 20-1, 20-2, 20-3.

The connectivity management device 11 searches for the causes of connection errors based on the environment information of data collection platform software and error logs. The connectivity management device 11 can involve functions such as Graphical User Interface (GUI) 101, Database for Error Suggestion 102, and Error Suggestion Function 103.

GUI 101 involves a suite of user interfaces for inputting the environment information and searching the causes of connection errors. For a worker 91 who installs and deploys data collection platform software, GUI 101 provides Category Spec Input 1011, Skill Attribution Input 1012, Error Input 1013, Error Suggestion Output 1014, and Knowledge database (DB) Update 1015. For an administrator 92 of the connectivity management device 11, GUI 101 provides Category Definition 1016, Weight Definition 1017, and Re-configuration Rule Definition 1018.

Database for Error Suggestion 102 has five kinds of databases. Input Information 1021 stores the environment information of data collection platform software. Knowledge DB 1022, Category DB 1023, and Weight DB 1024 as the database storing information for error causes search. Re-configuration Rule 1025 has programs to fix connection errors.

Error Suggestion Function 103 provides an algorithm for searching the causes of connection errors. Error Suggestion Function 103 has Error Collection 1031 collecting error logs, Error Suggestion Algorithm 1032 searching and outputting the error candidates, and Automated Configuration 1033 modifying configurations based on the error cause search results.

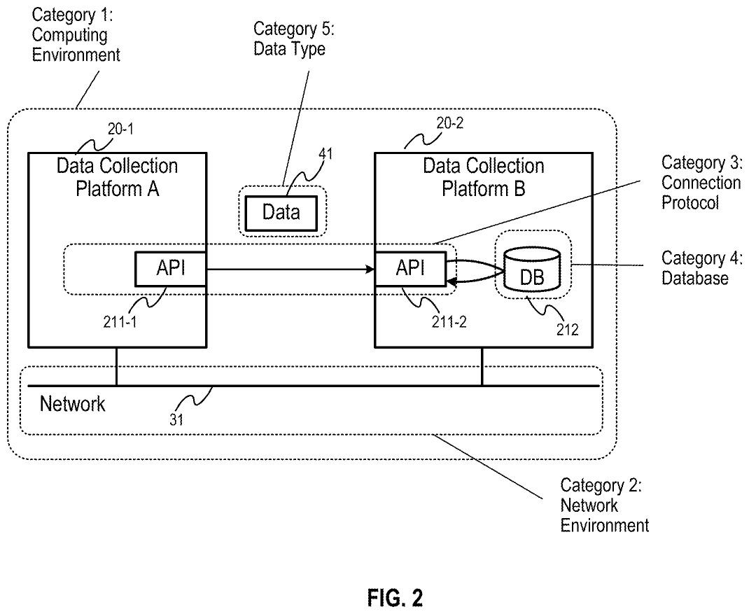

FIG. 2 illustrates an example of a category definition, in accordance with an example implementation. In the architecture of FIG. 2, data collection platform A 20-1 communicates with data collection platform B 20-2 over a network 31 via Application Programming Interfaces (APIs) 211-1, 211-2. For example, data collection platform A 20-1 transmits data 41 to data collection platform B 20-2, which is stored in database 212.

In this example architecture, the categories are defined by an administrator 92 according to deployment areas or deployment steps. The example in FIG. 2 shows five categories. The first one (Category 1) is a computing environment which includes the installation or configuration of virtual machines, containers, and so on. The second one (Category 2) is a network environment which includes the installation or configuration of Internet Protocol (IP) addresses, routing tables, firewall rules, wireless communication setups, and so on. The third one (Category 3) is a connection protocol which includes installation or configuration of communications protocols, APIs, security protocols, etc. The fourth one (Category 4) is the installation or configuration of database including authentications, APIs, tables, and so on. The last one (Category 5) is the configuration of data which is an exchange between data platforms. The data configuration includes data flow, data format, data size, sampling rate, and so on.

In the example of FIG. 2, the category with higher number is more common in several use-cases. And, the category with lower number is more dependent on the use-case. But, how to define the number of categories is flexible.

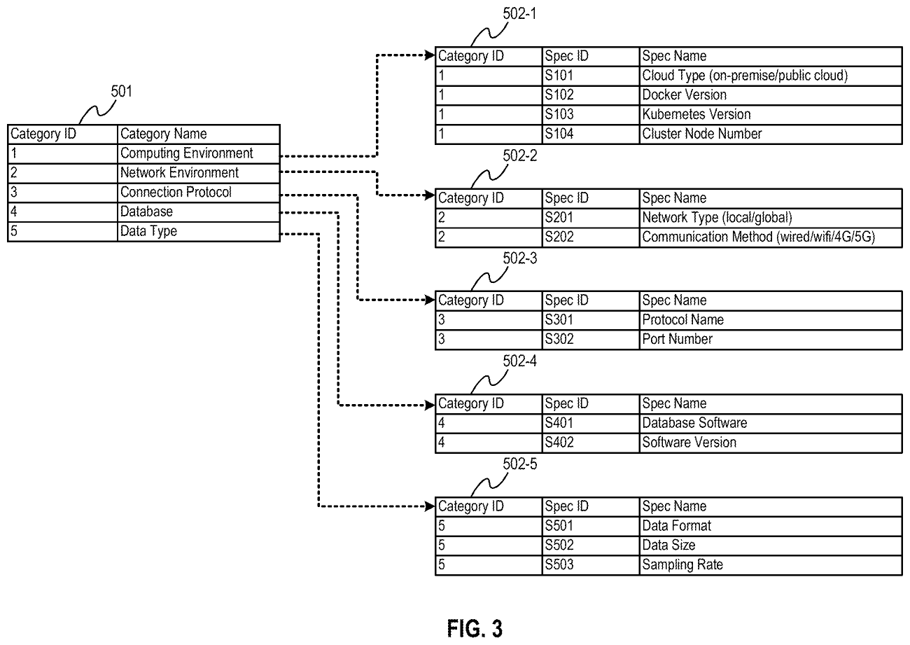

FIG. 3 illustrates an example of Category DB 1023, in accordance with an example implementation. Category DB 1023 can involve two types of tables. One type of table is Category ID Table 501 and another type of table is Category Spec Table 502-1, 502-2, 502-3, 502-4, 502-5. Category ID table 501 shows the relationship between Category ID and Category Name. In this example, Category ID table 501 includes the IDs and names of five categories shown in FIG. 2.

Category Spec Table 502-1, 502-2, 502-3, 502-4, 502-4 manages specification information for the installation and deployment for data collection platforms and can involve Category ID, Spec ID, and Spec Name. Spec ID is an identify for each specification item. Spec Name is the name of a specification name.

FIG. 3 illustrates Category Spec Table 502-1, 502-2, 502-3, 502-4, and 502-5 for five categories. For example, in Category Spec Table 502-1, for the Category 1 Computing Environment, four specification items are defined. The first one is the cloud-type, which indicates a local environment like on-premise or a cloud environment like public cloud service. The second one is a docker version which is a container software version. The third one is the version of Kubernetes, which is container management software. The fourth one is the number of nodes in the cluster of Kubernetes. Like this, for all categories set in Category ID table, specification tables are defined.

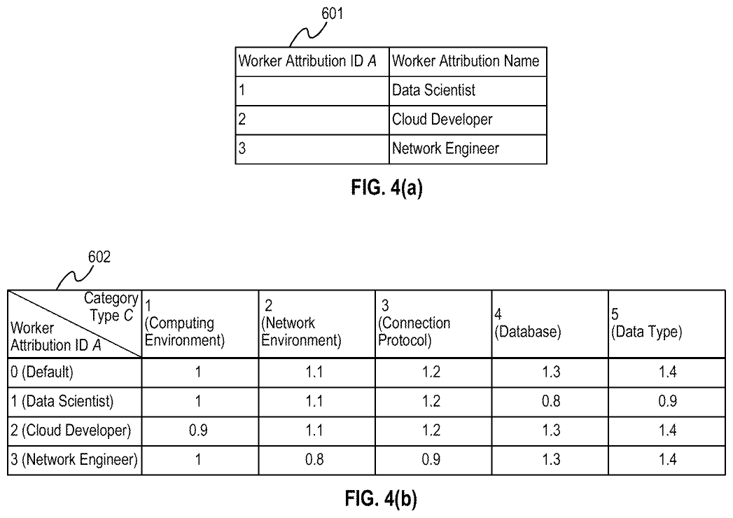

Next, Weight DB 1024 is explained below. FIGS. 4(a) and 4(b) illustrate an example of Weight DB 1024, in accordance with an example implementation. Weight DB 1024 involves Worker Attribution Table 601 shown in FIG. 4(a) and Weight Table 602 shown in FIG. 4(b).

Worker Attribution Table 601 has Worker Attribution ID A column and Worker Attribution Name column. Worker Attribution Name indicates several kinds of skill attributions. For examples, a data scientist is an engineer who is familiar with data processing, a cloud developer is an engineer has knowledge of cloud platform technologies like container technologies, and a network engineer is an engineer who is an expert of network protocols.

FIG. 4(b) shows an example of Weight Table 602. Weight table 602 is a matrix of Category ID C and Worker Attribution ID A. Here, Attribution ID A=0 means no indication about worker skills, and the weight with Attribution ID A=0 is set as default values. When the value of Worker Attribution A is not designated, the default values are used.

The administrator 92 of the connectivity management system 1 set these weights in Weight Table 602. In this example shown in FIG. 4(b), for default values, the weight value of the category with high value of L is set to a higher value because the category with higher value L is more dependent on the field environment.

In this example, for the data scientist with the Worker Attribution ID A=1, the weights of categories related to data processing, database and data type are set to lower values because the data scientist does not take a mistake in data processing configuration so often. In the same manner, for the cloud developer with the Worker Attribution ID A=2, the weight of Computing Environment category is set to a lower value, and for the network engineer with the Worker Attribution ID A=3, the weights of Network Environment category and Connection Protocol category are set to lower values.

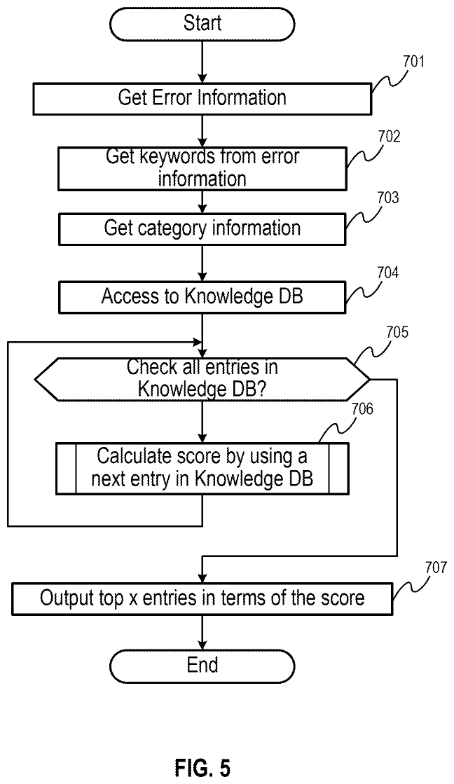

FIG. 5 illustrates a flow chart of the operations of the error cause search, in accordance with an example implementation. Firstly, Error Collection Function 1031 gets error information from a worker 91 or a data collection platform 21 at step 701.

Next, Error Collection Function 1031 gets keywords from the error information at step 702. For example, Error Collection Function 1031 parses the log message in the error information and extracts several words. Then, Error Collection Function 1031 inputs the extracted keywords to Error Suggestion Algorithm 1032.

Next, at step 703, Error Suggestion Algorithm 1032 gets the current environment information from Input Information 1021.

Next, at step 704, Error Suggestion Algorithm 1032 accesses Knowledge DB 1022. Then, Error Suggestion Algorithm 1032 starts to search for the cause of the input error by referring to each entry in Knowledge DB 1022.

At step 705, Error Suggestion Algorithm 1032 confirms whether all entries in Knowledge DB 1022 are processed or not. If no, then at step 706, Error Suggestion Algorithm 1042 calculates the score, which indicates the possibility as an error cause, by using a next entry in Knowledge DB 1032.

If yes, then at step 707, Error Suggestion Algorithm 1032 outputs top x entries in terms of the score to Error Suggestion Output GUI 1014 and Automated Configuration Function 1033.

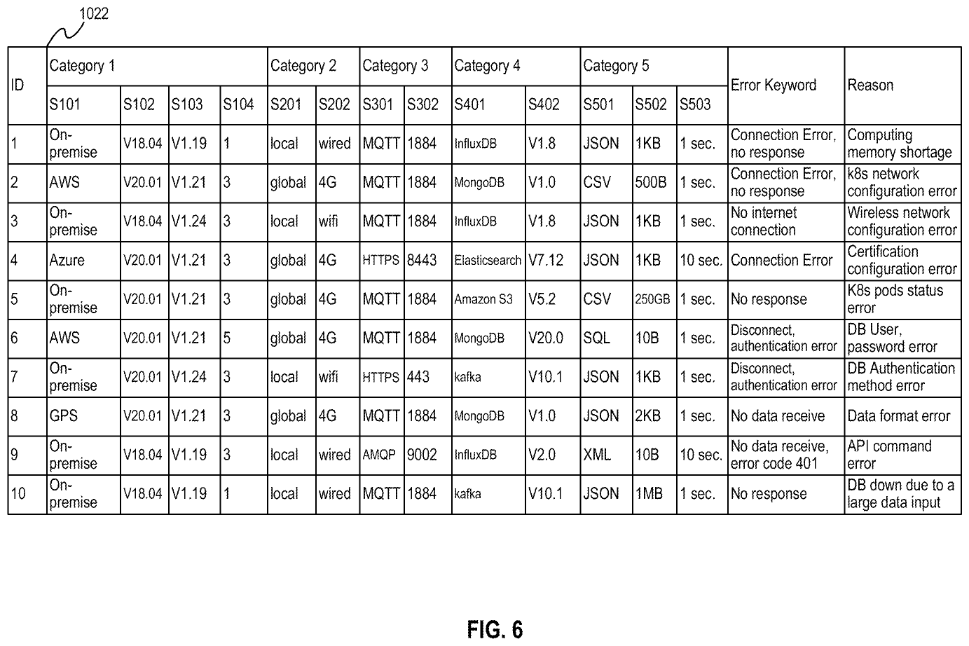

FIG. 6 illustrates an example of Knowledge DB 1022, in accordance with an example implementation. Knowledge DB 1022 stores error records in the past. Each error record includes conditions or parameters for each category's items of Category Spec Table 502-1, 502-2, 502-3, 502-4, and 502-5 shown in FIG. 3.

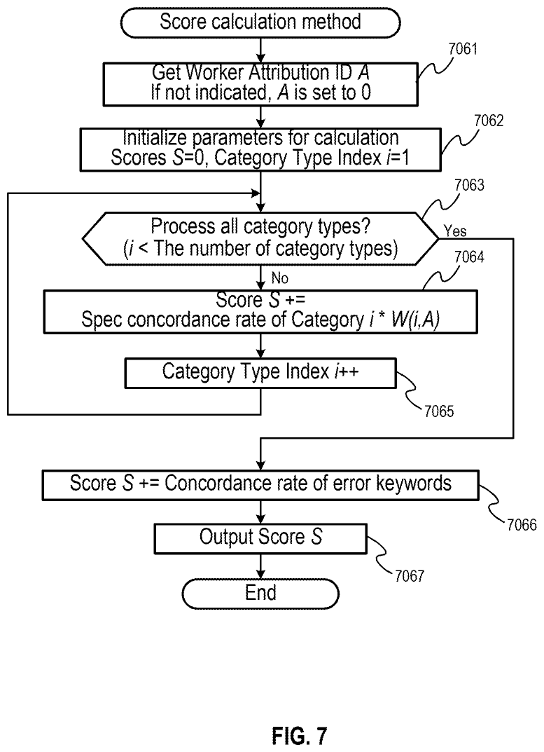

FIG. 7 illustrates a flow chart of the score calculation method which corresponds to 706 in FIG. 5, in accordance with an example implementation. Firstly, Error Suggestion Algorithm 1032 gets Worker Attribution A at step 7061. If the worker attribution is not indicated, A is set to 0 which is a default value.

Next, at step 7062, Error Suggestion Algorithm 1032 initializes parameters for the score calculation. Concretely, the value of score S is set to 0, and the value of category type index i is set to 1.

Next, at step 7063, Error Suggestion Algorithm 1032 confirms whether all category types are processed or not. If no, then at step 7064, Error Suggestion Algorithm 1032 calculates the score by checking the category type. The formula is as follows.

Score S+=the spec concordance rate of Category i*Weight (i, A)

Then, the category type index i is increased at step 7065.

If yes, then at step 7066, as a final step of the score calculation, the concordance rate of error keywords is added to the Score.

Finally, Error Suggestion Algorithm 1032 outputs the value of Score S at step 7067.

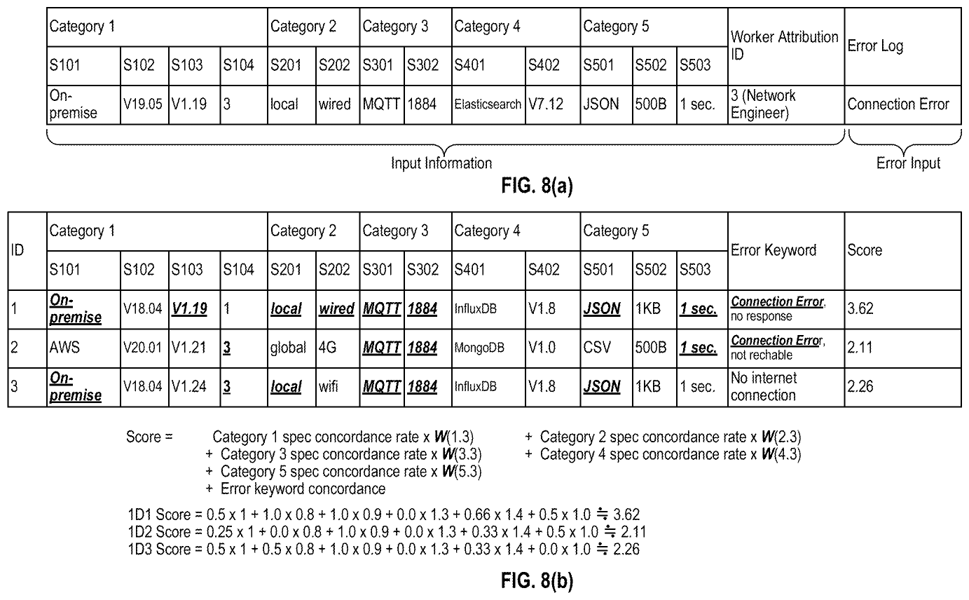

FIGS. 8(a) and 8(b) illustrates an example of the score calculation, in accordance with an example implementation. FIG. 8(a) illustrates an example of input error information. The input error information includes the spec information of each category and Worker Attribution ID A, which are obtained from the input information 1021. Also, the input error information includes the error log from the error input GUI 1013 and data collection platform 21.

FIG. 8(b) illustrates examples of the score calculations using knowledge DB. The score calculation formula is as follows.

$$Score S = {\sum }_{i = 0}^{n} the spec concordance rate of category i * W ( i , A ) + the concordance rate of error keywords * {W}_{e r r o r}$$

The spec concordance rate of category i is defined as the ratio of the number of matching spec items to the total number of spec items in category i. Also, the concordance rate of error keywords is defined as the ratio of the number of matching error keywords to the total number of error keywords.

FIG. 8(b) illustrates three score calculation examples. These examples use the values of Weight IV(i, A) shown in FIG. 4(b). Also, the value of Wₑᵣᵣₒᵣ is set to 1.

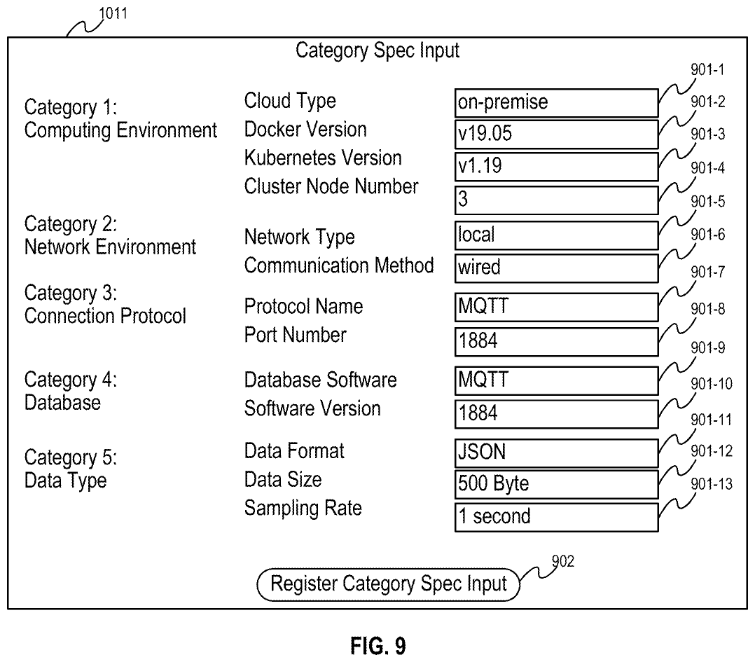

Next, the GUIs for executing the score calculation are explained as follows. FIG. 9 illustrates an example of Category Spec Input GUI 1011, in accordance with an example implementation. A user inputs the specs of data collection platforms' environment with spec input fields from 901-1, 901-2, 901-3, 901-4, 901-5, 901-6, 901-7, 901-8, 901-9, 901-10, 901-11, 901-12, and 901-13, and then registers by clicking Register Category Spec Input Button 902. This information is used as a part of the input information for the score calculation, which is shown in FIG. 8(a).

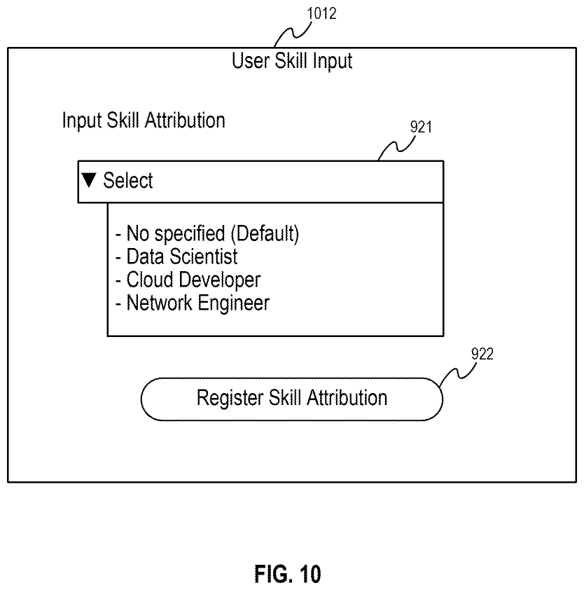

FIG. 10 illustrates an example of a User Skill Input GUI 1012, in accordance with an example implementation. A user selects its own skill attribution from a skill attribution list 921, and then registers by clicking Register Skill Attribution button 922. Based on the information, the skill attribution ID is determined for the score calculation.

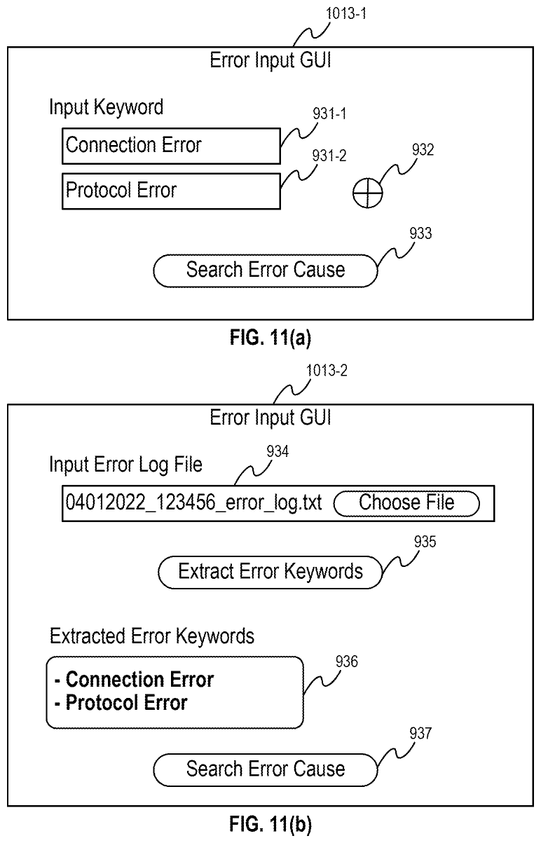

FIGS. 11(a) and 11(b) illustrate examples of Error Input GUI 1013, which are two methods to input the information, in accordance with an example implementation. FIG. 11(a) shows the example of a keyword input type of Error Input GUI 1013-1. A user input a keyword in an error log in a keyword input field 931-1, 931-2. Also, the user can input several keywords by adding an input field 931-1, 931-2 with the button 932. When the user clicks Search Error Cause button 933, the connectivity management device 11 executes the score calculation.

FIG. 11(b) shows the example of an error log file upload type of Error Input GUI 1013-2. A user uploads the error log file by using the file selection form 934. Then, when the user clicks Extract Error Keywords button 935, the connectivity management device 11 reads the selected file and extracts keywords from the file. The extracted error keywords are displayed in a text box 936. When the user clicks Search Error Cause button 937, the connectivity management device 11 executes the score calculation.

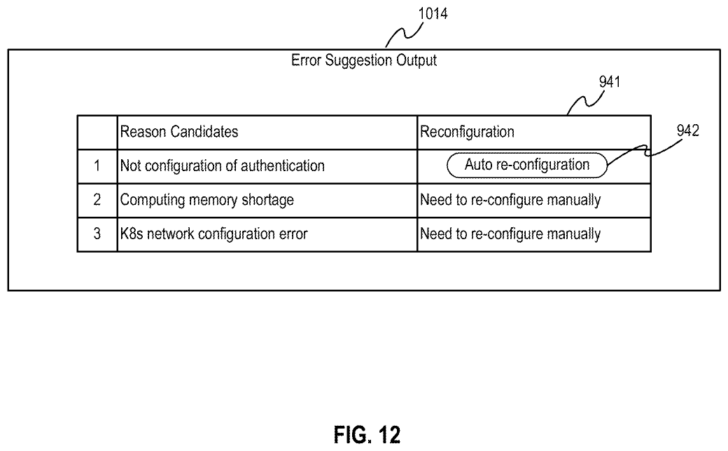

FIG. 12 illustrates an example of Error Cause Suggestion Output GUI 1014, in accordance with an example implementation. This GUI shows several candidates of the error cause in the descending order of the score at a table 941.

Further, this GUI has an Auto re-configuration button 942 which executes the program to fix automatically. When a user clicks Auto re-configuration button 942, the Automated Configuration Function 1033 accesses Re-configuration Rule table 1025. The program file of the indicated Knowledge ID is executed.

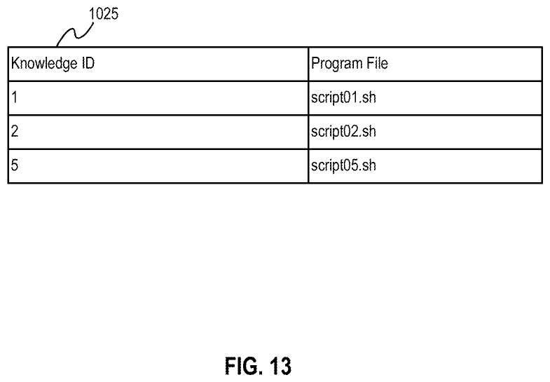

FIG. 13 illustrates an example of Re-configuration Rule 1025, in accordance with an example implementation. This table involves Knowledge ID and the program file name.

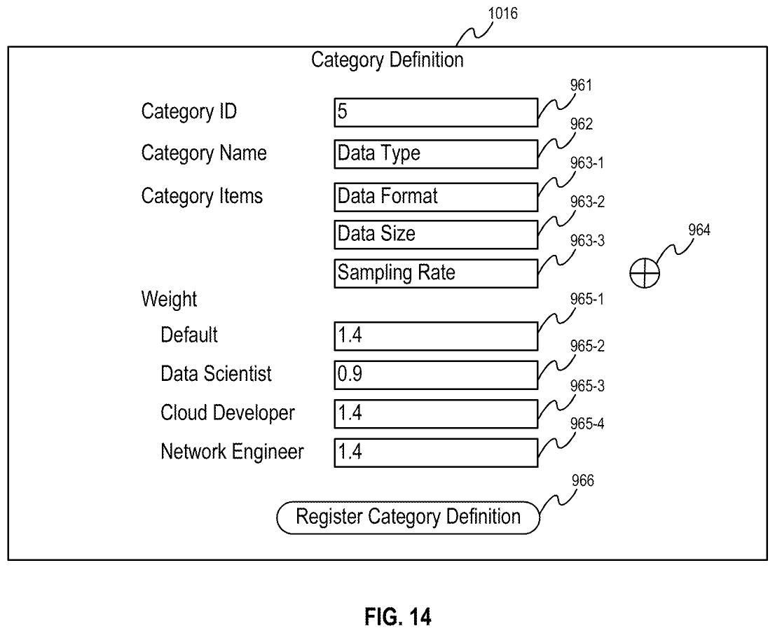

Next, the GUIs for setting the connectivity management device 11 are explained as follows. FIG. 14 illustrates an example of Category Definition GUI 1016, in accordance with an example implementation. An administrator defines Category ID 961, Category Name 962, Category Items 963-1, 963-2, 963-3 which can be added by a button 964, and Weights 965-1, 965-2, 965-3, 965-4. When the administrator clicks Register Category Definition button 966, the input information from 961 to 965 is added to Category DB 1023.

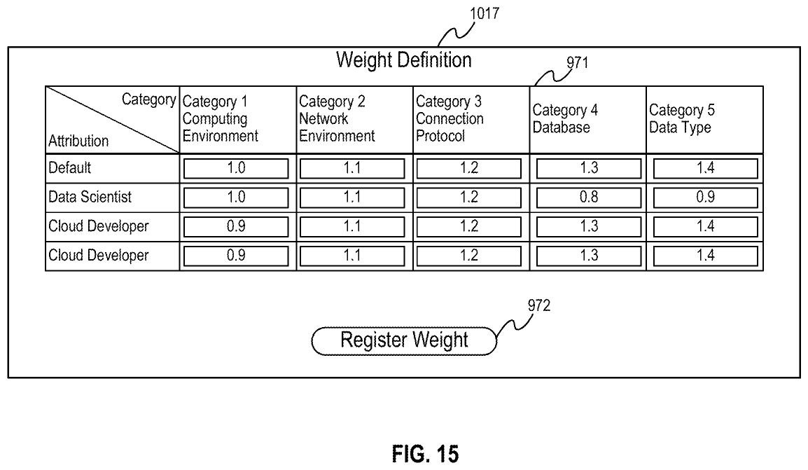

FIG. 15 illustrates an example of Weight Definition GUI 1017, in accordance with an example implementation. An administrator can see all of weights set in the pair of Category ID and User Skill Attribution ID in a weight value table 971. Further, the administrator adjusts the weight values in consideration of the total balance by editing weight value fields in the weight value table 971 and registering the weights by clicking the register weight button 972.

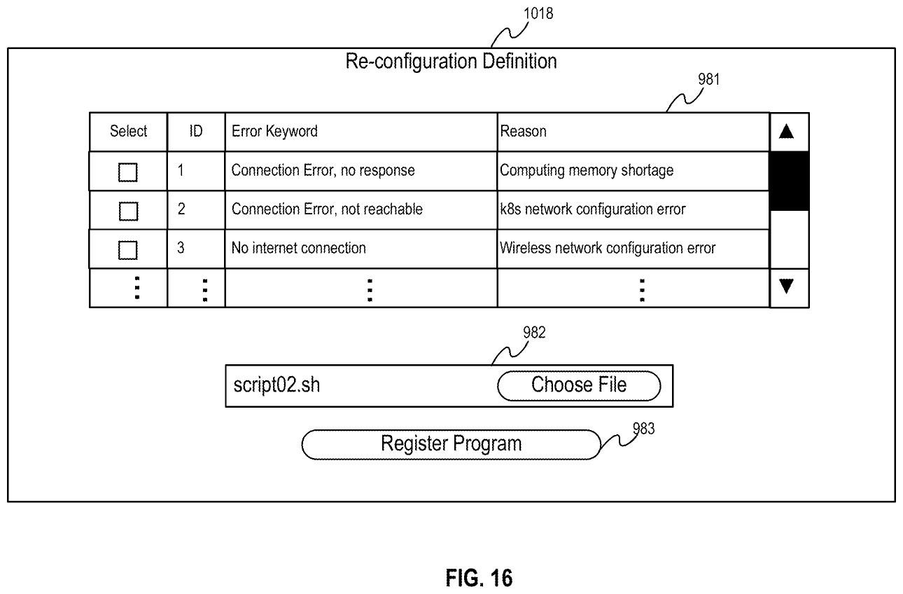

FIG. 16 illustrates an example of Re-configuration Rule Definition GUI 1018 to register a program to fix an error, in accordance with an example implementation. An administrator selects an error pattern corresponding to the program from knowledge lists 981. Then, the administrator uploads the program file in the box 982. When the administration registers the program file by clicking Register Program Button 983, Re-configuration Rule 1025 is updated.

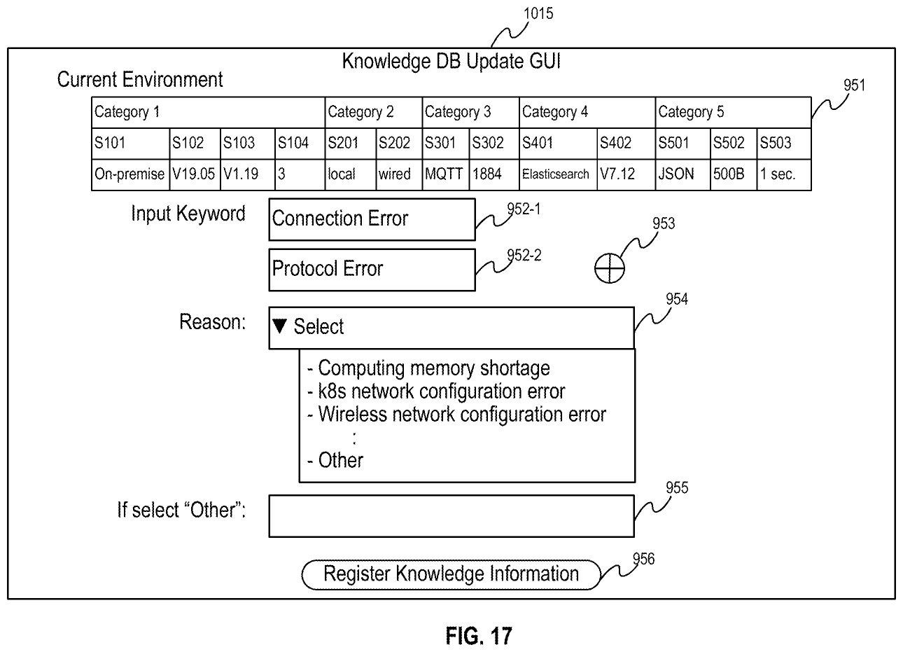

FIG. 17 illustrates an example of Knowledge DB Update GUI 1015 to register connection error history information, in accordance with an example implementation. For a current environment information 951, a user or an administrator inputs error keywords by using keyword input fields 952-1, 952-2 and field additional button 953. Then, the user or the administrator inputs an error reason with the past reason list 954 which includes the information in Knowledge DB 1022. When “Other” is selected, a new reason can be inputted in a field 955. When the administration registers the program file by clicking Register Knowledge Button 956, Knowledge DB 1022 is updated.

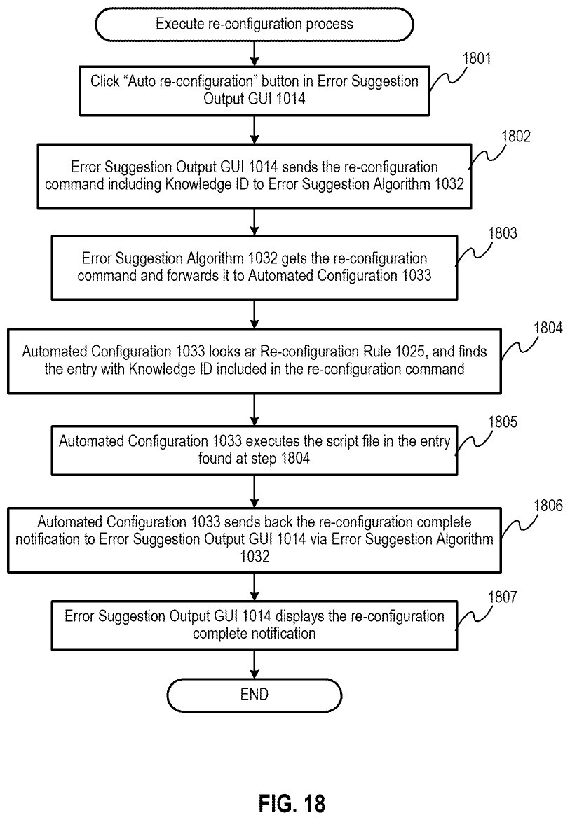

An example of the re-configuration process is as follows. FIG. 18 illustrates a flow chart of the re-configuration process, in accordance with an example implementation. Firstly, at step 1801, in order to start the re-configuration process, the user clicks “Auto re-configuration” button in Error Suggestion Output GUI 1014 as shown in FIG. 12.

Next, at step 1802, Error Suggestion Output GUI 1014 sends the re-configuration command to Error Suggestion Algorithm 1032. The re-configuration command includes Knowledge ID which corresponds to the entry designated by the user at step 1801.

Then, at step 1803, Error Suggestion Algorithm 1032 gets the re-configuration command and forwards it to Automated Configuration 1033.

Next, at step 1804, Automated Configuration 1033 gets the re-configuration command, looks at Re-configuration Rule 1025 as shown in FIG. 13, and finds the entry with Knowledge ID included in the re-configuration command.

Then, at step 1805, Automated Configuration 1033 executes the script file in the entry found at step 1804. Based on the script file, Data Collection Platform 20 changes its configuration.

After the completion of the script, at step 1806, Automated Configuration 1033 sends back the re-configuration complete notification to Error Suggestion Output GUI 1014 via Error Suggestion Algorithm 1032.

Finally, at step 1807, Error Suggestion Output GUI 1014 displays the re-configuration complete notification to the user.

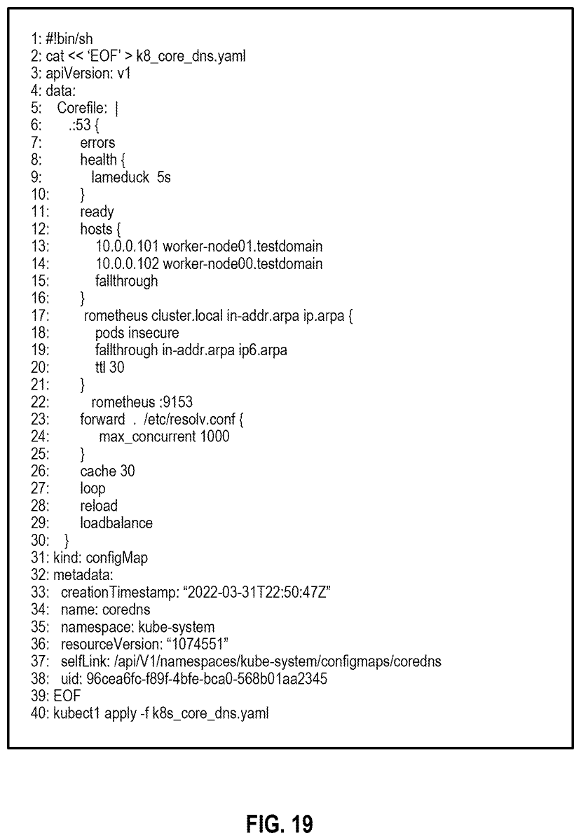

FIG. 19 shows an example of the script file script02.sh for the re-configuration, in accordance with an example implementation. The script file script02.sh is mapped to Knowledge ID 2 which indicates k8s network configuration error. The script file executes to add the information of k8s (Kubernetes), which is a type container management software, and cluster nodes to k8s core DNS (Domain Name System). Core DNS converts the domain name of containers in k8s environment into IP addresses. Such additional information is required to set up the network configuration correctly in k8s environment.

Line 2-line 39 illustrates instructions to create the configuration file, and line 40 illustrates instructions to register the configuration file in k8s environment.

As in this example, by preparing the script file and mapping it to Knowledge ID in Re-configuration Rule 1025, the re-configuration can thereby be executed automatically.

Through the example implementations described herein, time for finding the cause for the connection error can be reduced, thereby reducing the costs of deploying the software system. Further, the error causes can thereby be found without expert consultation.

For some errors, based on the error detections, the system automatically executes the proper configuration and modification. Further, the example implementations described herein considers the worker skills and characteristic because of weights according to environment or worker skills.

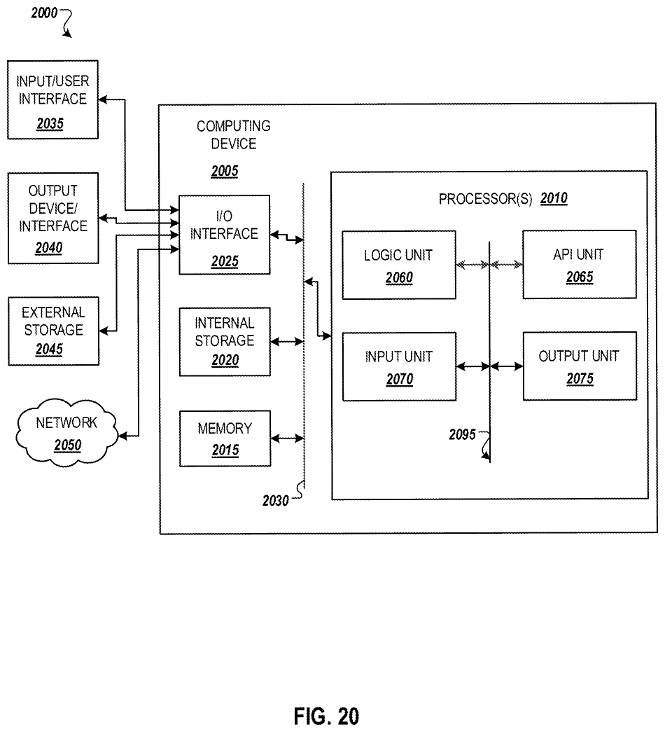

FIG. 20 illustrates an example computing environment with an example computer device suitable for use in some example implementations, such as a connectivity management device 10 or a data collection platform as illustrated in FIG. 1.

Computer device 2005 in computing environment 2000 can include one or more processing units, cores, or processors 2010, memory 2015 (e.g., RAM, ROM, and/or the like), internal storage 2020 (e.g., magnetic, optical, solid state storage, and/or organic), and/or I/O interface 2025, any of which can be coupled on a communication mechanism or bus 2030 for communicating information or embedded in the computer device 2005. I/O interface 2025 is also configured to receive images from cameras or provide images to projectors or displays, depending on the desired implementation.

Computer device 2005 can be communicatively coupled to input/user interface 2035 and output device/interface 2040. Either one or both of input/user interface 2035 and output device/interface 2040 can be a wired or wireless interface and can be detachable. Input/user interface 2035 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 2040 may include a display, television, monitor, printer, speaker, braille, or the like. In some example implementations, input/user interface 2035 and output device/interface 2040 can be embedded with or physically coupled to the computer device 2005. In other example implementations, other computer devices may function as or provide the functions of input/user interface 2035 and output device/interface 2040 for a computer device 2005.

Examples of computer device 2005 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 2005 can be communicatively coupled (e.g., via I/O interface 2025 ) to external storage 2045 and network 2050 for communicating with any number of networked components, devices, and systems, including one or more computer devices of the same or different configuration. Computer device 2005 or any connected computer device can be functioning as, providing services of, or referred to as a server, client, thin server, general machine, special-purpose machine, or another label.

I/O interface 2025 can include, but is not limited to, wired and/or wireless interfaces using any communication or I/O protocols or standards (e.g., Ethernet, 802.11x, Universal System Bus, WiMax, modern, a cellular network protocol, and the like) for communicating information to and/or from at least all the connected components, devices, and network in computing environment 2000. Network 2050 can be any network or combination of networks (e.g., the Internet, local area network, wide area network, a telephonic network, a cellular network, satellite network, and the like).

Computer device 2005 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 2005 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Peri, JavaScript, and others).

Processor(s) 2010 can execute under any operating system (OS) (not shown), in a native or virtual environment. One or more applications can be deployed that include logic unit 2060, application programming interface (API) unit 2065, input unit 2070, output unit 2075, and inter-unit communication mechanism 2095 for the different units to communicate with each other, with the OS, and with other applications (not shown). The described units and elements can be varied in design, function, configuration, or implementation and are not limited to the descriptions provided.

In some example implementations, when information or an execution instruction is received by API unit 2065, it may be communicated to one or more other units (e.g., logic unit 2060, input unit 2070, output unit 2075 ). In some instances, logic unit 2060 may be configured to control the information flow among the units and direct the services provided by API unit 2065, input unit 2070, output unit 2075, in some example implementations described above. For example, the flow of one or more processes or implementations may be controlled by logic unit 2060 alone or in conjunction with API unit 2065. The input unit 2070 may be configured to obtain input for the calculations described in the example implementations, and the output unit 2075 may be configured to provide output based on the calculations described in example implementations.

Processor(s) 2010 can be configured to execute methods and computer instructions involving, for an occurrence of a connection error between a first software and a second software, obtaining information comprising a plurality of context categories, each of the plurality of context categories associated with an operating environment of the first software and the second software (e.g., between different data collection platforms); searching an error history database (e.g., error collection 1031) based on the information and weight values associated with each of the plurality of context categories; and providing an estimated cause of the connection error based on the searching as illustrated at error suggestion algorithm 1032.

Depending on the desired implementation, the plurality of context categories can include one or more of computing environment, network environment, connection protocol, data type, and database as illustrated in FIG. 3.

Depending on the desired implementation, the weight values associated with the each of the plurality of context categories is obtained based on a worker attribution to the first software and the second software as illustrated in FIGS. 4(a) and 4(b).

Processor(s) 2010 can be further configured to execute method and computer instructions as described herein, which can also involve extracting keywords from connection error information associated with the connection information; and obtaining the operating environment of the first software and the second software based on the extracted keywords; wherein the searching the error history database based on the first information and the weight values associated with each of the plurality of context categories can involve scoring each entry in the error history database; wherein the providing an estimated cause of the connection error based on the searching comprises providing one or more of the top scoring ones of the each entry in the error history database as illustrated in FIG. 5. Depending on the desired implementation, the processor(s) 2010 can be configured to execute the method and instructions for the scoring the each entry in the error history database by scoring each entry in the error history database based on the associated weight values, a concordance of the extracted keywords to the each entry, and a concordance of contextual categories associated with the each entry to the plurality of context categories as illustrated in FIG. 7.

Depending on the desired implementation, processor(s) 2010 can be configured to execute the method and instructions described herein, and further include determining and executing a process to restore connectivity between the first software and the second software based on the estimated cause as illustrated in FIG. 18.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
for an occurrence of a connection error between a first software and a second software:
obtaining information comprising a plurality of context categories, each of the plurality of context categories associated with an operating environment of the first software and the second software:
searching an error history database based on the information and weight values associated with each of the plurality of context categories; and
providing an estimated cause of the connection error based on the searching.

2. The method of claim 1, wherein the plurality of context categories comprises one or more of computing environment, network environment, connection protocol, data type, and database.

3. The method of claim 1, wherein the weight values associated with the each of the plurality of context categories is obtained based on a worker attribution to the first software and the second software.

4. The method of claim 1, further comprising:
extracting keywords from connection error information associated with the connection information; and
obtaining the operating environment of the first software and the second software based on the extracted keywords;
wherein the searching the error history database based on the first information and the weight values associated with each of the plurality of context categories comprises:
scoring each entry in the error history database;
wherein the providing an estimated cause of the connection error based on the searching comprises providing one or more of top scoring ones of the each entry in the error history database.

5. The method of claim 4, wherein the scoring the each entry in the error history database comprises scoring each entry in the error history database based on the associated weight values, a concordance of the extracted keywords to the each entry, and a concordance of contextual categories associated with the each entry to the plurality of context categories.

6. The method of claim 1, further comprising determining and executing a process to restore connectivity between the first software and the second software based on the estimated cause.

7. A non-transitory computer readable medium, storing instructions for executing a process, the instructions comprising:
for an occurrence of a connection error between a first software and a second software:
obtaining information comprising a plurality of context categories, each of the plurality of context categories associated with an operating environment of the first software and the second software;
searching an error history database based on the information and weight values associated with each of the plurality of context categories; and
providing an estimated cause of the connection error based on the searching.

8. The non-transitory computer readable medium of claim 7, wherein the plurality of context categories comprises one or more of computing environment, network environment, connection protocol, data type, and database.

9. The non-transitory computer readable medium of claim 7, wherein the weight values associated with the each of the plurality of context categories is obtained based on a worker attribution to the first software and the second software.

10. The non-transitory computer readable medium of claim 7, further comprising:
extracting keywords from connection error information associated with the connection information; and
obtaining the operating environment of the first software and the second software based on the extracted keywords;
wherein the searching the error history database based on the first information and the weight values associated with each of the plurality of context categories comprises:
scoring each entry in the error history database;
wherein the providing an estimated cause of the connection error based on the searching comprises providing one or more of top scoring ones of the each entry in the error history database.

11. The non-transitory computer readable medium of claim 10, wherein the scoring the each entry in the error history database comprises scoring each entry in the error history database based on the associated weight values, a concordance of the extracted keywords to the each entry, and a concordance of contextual categories associated with the each entry to the plurality of context categories.

12. The non-transitory computer readable medium of claim 7, further comprising determining and executing a process to restore connectivity between the first software and the second software based on the estimated cause.

13. An apparatus, comprising:
a processor, configured to:
for an occurrence of a connection error between a first software and a second software:
obtain information comprising a plurality of context categories, each of the plurality of context categories associated with an operating environment of the first software and the second software;
search an error history database based on the information and weight values associated with each of the plurality of context categories; and
provide an estimated cause of the connection error based on the searching.

14. The apparatus of claim 13, wherein the plurality of context categories comprises one or more of computing environment, network environment, connection protocol, data type, and database.

15. The apparatus of claim 13, wherein the weight values associated with the each of the plurality of context categories is obtained based on a worker attribution to the first software and the second software.

16. The apparatus of claim 13, further comprising:
extracting keywords from connection error information associated with the connection information; and
obtaining the operating environment of the first software and the second software based on the extracted keywords;
wherein the searching the error history database based on the first information and the weight values associated with each of the plurality of context categories comprises:
scoring each entry in the error history database;
wherein the providing an estimated cause of the connection error based on the searching comprises providing one or more of top scoring ones of the each entry in the error history database.

17. The apparatus of claim 16, wherein the processor is configured to score the each entry in the error history database comprises scoring each entry in the error history database based on the associated weight values, a concordance of the extracted keywords to the each entry, and a concordance of contextual categories associated with the each entry to the plurality of context categories associated with one or more of the plurality of context categories.

18. The apparatus of claim 13, the processor further configured to determine and execute a process to restore connectivity between the first software and the second software based on the estimated cause.
